(19) United States
(12) Patent Application Publication
(10) Pub. No.: US 2017/0070912 A1
(43) Pub. Date: Mar. 9, 2017

(54) METHOD AND APPARATUS FOR PROGRAMMABLE SPECTRUM SWITCHING LICENSED AND UNLICENSED SPECTRUM

(71) Applicant: ARGELA-USA, INC., Sunnyvale, CA (US)

(72) Inventors: ULAS CAN KOZAT, MOUNTAIN VIEW, CA (US); MEHMET OGUZ SUNAY, SAN FRANCISCO, CA (US)

(21) Appl. No.: 15/260,289

(22) Filed: Sep. 8, 2016

Related U.S. Application Data
(60) Provisional application No. 62/215,564, filed on Sep. 8, 2015.

(51) Int. Cl. H04W 28/08; H04L 12/741; H04L 12/709; H04W 16/14

(52) U.S. Cl. CPC H04W 28/08; H04W 16/14; H04L 45/745; H04L 45/245; H04W 84/042

(57) ABSTRACT

A programmable spectrum switch located on a single node has a first radio access technology (RAT) interface communicating utilizing the licensed frequency spectrum; and a second RAT interface communicating utilizing the unlicensed frequency spectrum. A flow table may be maintained having a flow-matching rule and a corresponding forwarding action represented by a weight, wherein the flow-matching rule is specified by matching, fully or partially, one or more fields in a packet header to specific values, and wherein a specific weight value associated with the weight specifies one of the following: (a) what fraction of packets should be forwarded to the first RAT interface, (b) a code vector associated with a unique policy, (c) multicasting over both the first and second RAT interfaces, or (d) coded multicasting where packets of the matching flow are encoded together and forwarded in a round robin fashion via the first and second RAT interfaces.

### RELATED APPLICATIONS

This application claims benefit of U.S. provisional application Ser. No. 62/215,564 filed on Sep. 8, 2015.

### BACKGROUND OF THE INVENTION

Field of Invention

The present application relates to the licensed and unlicensed spectrum use of wireless broadband communication systems, and more particularly, methods and apparatus for programmatically assigning packets of flows to one or more radio access technologies utilizing different frequency bands by means of a spectrum switch.

Discussion of Related Art

This invention is concerned with the specification of a method and apparatus for forwarding packets of flows to one or more radio access technologies (RATs) utilizing unlicensed and licensed bands programmatically.

A number of related art exists. The patent application, US 2015/0126207 A1 considers LTE access points (APs) utilizing the unlicensed spectrum and providing measurements to an LTE base station, which in return reallocates the channels in the unlicensed spectrum to individual LTE APs. The disclosure specifies priorities of each frequency band at each LTE AP location based on the level of interference or traffic activity happening in each frequency band.

The patent specification U.S. Pat. No. 9,031,017 B2 considers an LTE base station to transmit for a time period over an unlicensed band after detecting the medium is clear. As part of using the unlicensed spectrum, power control is also carried out to limit the range of interference.

The patent application US20150063098 A1 discloses methods for switching small cells using unlicensed spectrum to low utilization modes to limit the usage of unlicensed spectrum both in time and frequency when the load of small cells drops below a preset threshold.

The patent application WO2015009433 A1 specifies a reservation method over the unlicensed spectrum where a base station after performing clear channel assessment broadcasts a first signal during the first time period to announce downlink transmissions to a particular UE over a second time period.

The patent specification U.S. Pat. No. 8,874,124 B2 specifies a dual-band base station that uses one radio access technology in the licensed band (e.g., LTE) and replaces the physical layer communication of the said radio access technology with another physical layer technology to be used over the unlicensed band (e.g., WiFi). The base station in either case is seen as a regular base station to the core network, while from UE perspective it can be seen as a base station or a hot spot access point. UE and the base station compare the conditions (e.g., load, bandwidth, interference, etc.) between the licensed and unlicensed band, initiate a signaling to switch between the two bands.

The patent application US20150065152 A1 specifies an opportunistic carrier aggregation framework using both licensed and unlicensed bands. One or more metrics are used to switch on/off one or more bands from the unlicensed spectrum. The metrics can be cell loading, traffic type, QoS indication, number of users in the unlicensed band, available backhaul bandwidth, and interference from access points. The bands in the unlicensed bands are divided into preferred and non-preferred sets with more bias associated with the bands in the preferred set to be selected for communication.

Embodiments of the present invention are an improvement over prior art systems and methods.

### SUMMARY OF THE INVENTION

In one embodiment, the present invention provides a programmable spectrum switch located on a single node comprising: (a) a first radio access technology (RAT) interface communicating utilizing the licensed frequency spectrum; and (b) a second RAT interface communicating utilizing the unlicensed frequency spectrum.

In another embodiment, the present invention provides a programmable spectrum switch located on a single node comprising: (a) a first radio access technology (RAT) interface communicating utilizing the licensed frequency spectrum; (b) a second RAT interface communicating utilizing the unlicensed frequency spectrum, wherein the programmable spectrum switch stores a flow table having a flow-matching rule and a corresponding forwarding action represented by a weight.

In yet another embodiment, the present invention provides an article of manufacture comprising non-transitory computer storage medium storing computer readable program code which, when executed by a processor in a single node, implements a programmable spectrum switch, the computer storage medium comprising: computer readable program code executed by the processor to implement a first radio access technology (RAT) interface communicating utilizing the licensed frequency spectrum; computer readable program code executed by the processor to implement a second RAT interface communicating utilizing the unlicensed frequency spectrum; and computer readable program code executed by the processor to maintain a flow table having a flow-matching rule and a corresponding forwarding action represented by a weight, wherein the flow-matching rule is specified by matching, fully or partially, one or more fields in a packet header to specific values, and wherein a specific weight value associated with the weight specifies one of the following: (a) what fraction of packets should be forwarded to the first RAT interface utilizing the licensed frequency spectrum (b) a code vector associated with a unique policy, (c) multicasting over both the first and second RAT interfaces, and (d) coded multicasting where one or more packets of the matching flow are encoded together and encoded packets are forwarded in a round robin fashion via the first and second RAT interfaces.

### BRIEF DESCRIPTION OF THE DRAWINGS

The present disclosure, in accordance with one or more various examples, is described in detail with reference to the following figures. The drawings are provided for purposes of illustration only and merely depict examples of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 shows a wireless node that supports two Radio Access Technologies (RATs), one to be used for licensed spectrum and the other to be used for unlicensed spectrum.

FIG. 2 shows one Spectrum Controller programming multiple wireless nodes via instructing and/or configuring Spectrum Switches in each wireless node.

FIG. 3 shows a flow table supported at each Spectrum Switch that indicates how the packets of each flow should be split.

FIG. 4 depicts how an incoming flow is split on to two RATs based on its weight in the flow table.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein.

Unlicensed frequency spectrum provides an unreliable yet freely available high data rate medium for network operators. Prior art provides several physical layer methods and apparatus for carrier aggregation utilizing both licensed and unlicensed frequency spectrum. The invention presented herein simplifies the wireless node architecture that achieves the same objective so that a single RAT that supports both licensed and unlicensed bands is not required. In the present invention, different RATs on the same node are aggregated together via a programmable switch. Thus, unlike prior art, the invention provides a programmable spectrum access. The invention discloses a programmable wireless node, which can be a base station or a user equipment, that supports two radio access technologies (RATs), one to be used over the unlicensed bands and the other to be used over the licensed bands. The RAT for the unlicensed bands can be an IEEE 802.11 standards family based air interface, or a 3GPP standards-family based air interface, or any other air interface that is operational in the unlicensed band. The RAT for the licensed spectrum can be any of the existing or future standards solution, mainly developed for cellular communications by the 3GPP or any other air interface that is operational in a licensed band. The invention conducts carrier aggregation at the RAT level, rather than the physical layer.

The programmable wireless node provides a Spectrum Switch that forwards the downlink packets from the upper layers to one or both (e.g., multicasting supported) of RATs or forwards the uplink packets received by both RATs to the upper layers. For programmability, the Spectrum Switch provides a special flow table with each row specifying a flow-matching rule and a forwarding action represented by a non-negative weight. The flow-matching rule can be specified by matching one or more fields in the packet headers to specific values fully or partially (e.g., the destination IP address). When its value is between 0 and 1, the non-negative weight specifies what fraction of packets for the matching flow should be forwarded to the RAT serving the licensed spectrum. When its value is set higher than 1, the weight represents a code vector specifying a unique policy. For instance, a weight value of 2 can signify multicasting such that an IP packet can be copied and forwarded on both interfaces. A weight value of 3 can signify a coded multicasting where one or more packets of the matching flow is encoded together and each encoded packet are forwarded in a round robin fashion onto each interface.

The programmable wireless node looks like a regular base station or regular user equipment to the core network and to the radio access network. Even when the WiFi air interface is used for the unlicensed band, the UE is still connected to the core network of the cellular air interface operating in the licensed band, following the same procedures for authentication, authorization, mobility management, IP address allocation, etc. The usage of one RAT or the other or both is transparent to the network and transport layers. From users point of view, UE is still connected to the same mobile operator.

The Spectrum Switch collects the packet delivery statistics (e.g., block error rates, packet drops, number of re-transmissions, etc.) as well as bandwidth utilization (i.e., load) from both RATs. The collected statistics are reported on-demand or pro-actively to a remote Spectrum Controller. The Spectrum Controller programs the flow table by specifying the flow rules and the corresponding weights based on these statistics. Due to the centralization of decision making on spectrum usage, the policy needs to be updated only at the Spectrum Controller, which pushes the rules according to the new policies to the base stations and UEs.

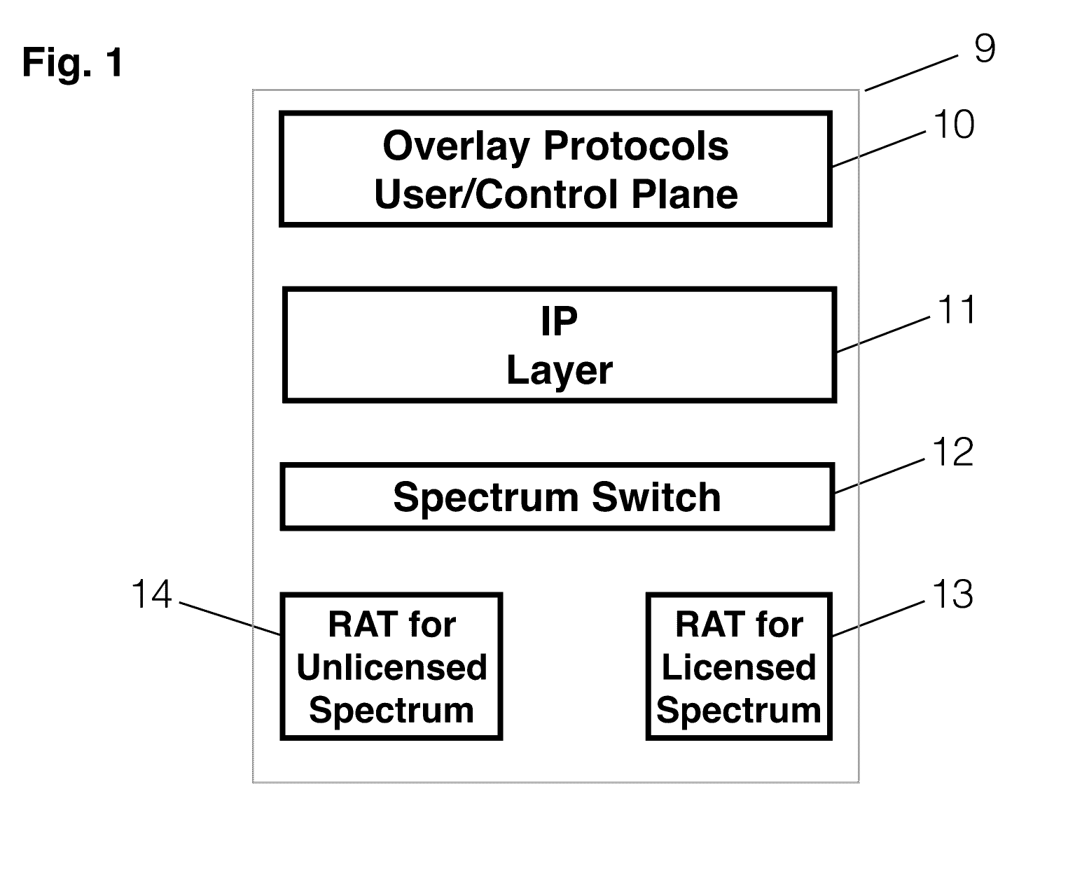

The present invention in one embodiment discloses a programmable wireless node architecture (9 in FIG. 1) that is comprised of dual radio accesses technology (RAT), one RAT utilizing licensed spectrum of the mobile operator deploying the said switch (13 in FIG. 1) and one RAT utilizing unlicensed spectrum that can be used by any other wireless network (14 in FIG. 1). Both the licensed and unlicensed spectrum can be composed of one contagious block of frequency bands or can be a union of multiple disjoint blocks of frequency bands. In one embodiment, both RATs are the same, e.g., any 3GPP standard such as LTE, LTE-A, LTE-B, etc. In another embodiment, RAT for the licensed spectrum and RAT for the unlicensed spectrum are different. A typical deployment set RAT for the licensed spectrum as one of LTE, LTE-A, LTE-B, etc. and set RAT for the unlicensed spectrum as one of the IEEE 802.11 or WiFi standards. Another deployment set RAT for the licensed spectrum as LTE, while setting RAT for the unlicensed spectrum as LTE-A or LTE-B.

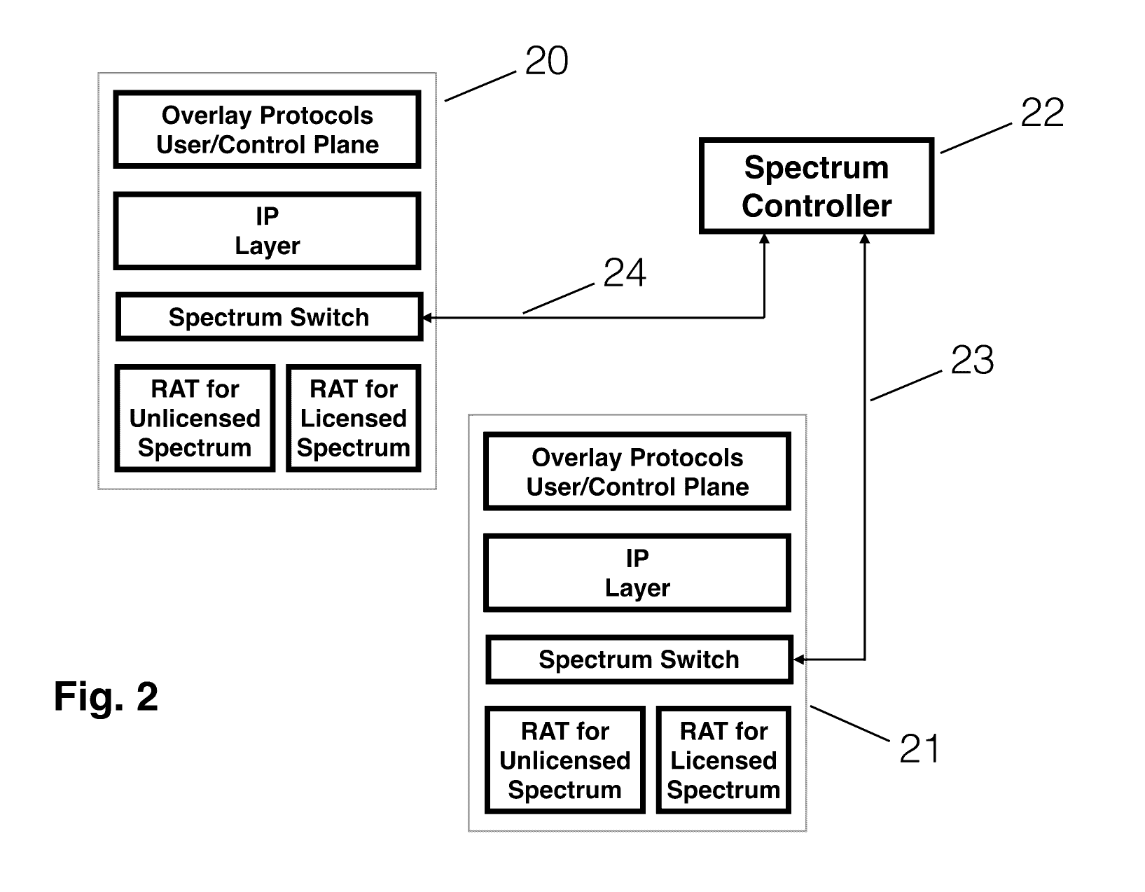

The core programmable component of the wireless node is the Spectrum Switch (12 in FIG. 1). The Spectrum Switch is a remotely programmable layer implemented in software, hardware, or combination of both that exposes an interface (e.g., 23 & 24 in FIG. 2 are instances of said interface) to a remote Spectrum Controller (22 in FIG. 2). The Spectrum Switch in one embodiment is an internal switch with sole purpose of passing packets between the IP layer and RAT modules. The IP packets received from the IP layer (11 in FIG. 1) are to be transmitted over the air from the wireless node and they are switched by the Spectrum Switch onto one or both of the RATs. Each RAT supports its full physical layer, MAC layer, and link layer support with coding, modulation, MIMO, wireless transmission, packet fragmentation, wireless scheduling, retransmission, HARQ, etc. contained within the RAT module and performed transparent to the Spectrum Switch. The packets received by each RAT are put back into the IP packet format before passed onto the Spectrum Switch that passes IP packets to the IP layer. IP layer passes the application packets to the overlay protocols (10 in FIG. 1) based on the port number in the transport header (e.g., destination port number in TCP/UDP/SCTP header). Overlay protocols are the standard data plane or control plane functions implementing different interfaces in 3GPP standards (e.g., S1 interface, X2 interface, etc.). Overlay protocols communicate with each other over IP. When an IP packet is received and it should be sent over the air to user equipment (UE), the packet is passed onto the IP layer to be forwarded towards one of the RATs transparent to the overlay protocol.

In another embodiment the IP layer and the overlay protocols can be located on a remote node and Spectrum Switch is connected to a layer-1 or layer-2 switch (e.g., an optical switch or Ethernet switch) for layer-1 or layer-2 based forwarding to the specific remote location. In another embodiment, Spectrum Switch can be integrated with the said layer-1 or layer-2 switch. The said layer-1 or layer-2 switches are themselves programmable through a protocol such as OpenFlow.

Spectrum Controller (22 in FIG. 2) and Spectrum Switch (12 in FIG. 1) are the core embodiments of the invention. Spectrum Controller is responsible for programming switching rules for the licensed and unlicensed spectrum on a plurality of wireless nodes. These wireless nodes can be base stations and/or UEs. Spectrum Controller is itself configured, programmed, or instructed by a network management entity as a central control point to program the spectrum access and traffic optimization/offloading policies on all the programmable nodes under the authority of Spectrum Controller at once. Spectrum Controller receives statistics about the traffic conditions and performance (e.g., round trip time delays over the link layer, block error rates, packet drop rates, queue backlogs, etc.) from Spectrum Switches. Spectrum Controller received the QoS profiles of each traffic flow from another network entity that holds user and application profiles. In exchange, Spectrum Controller programs forwarding rules on Spectrum Switches via adding, deleting, modifying flow tables on Spectrum Switches. Unlike the traditional flow tables that specify a rule for flow matching (e.g., all packets with IP destination address IPy) and a direct forwarding action (e.g., forward to next table, forward to port x, etc.), the flow table of the disclosed invention provides a forwarding policy for licensed and unlicensed spectrum.

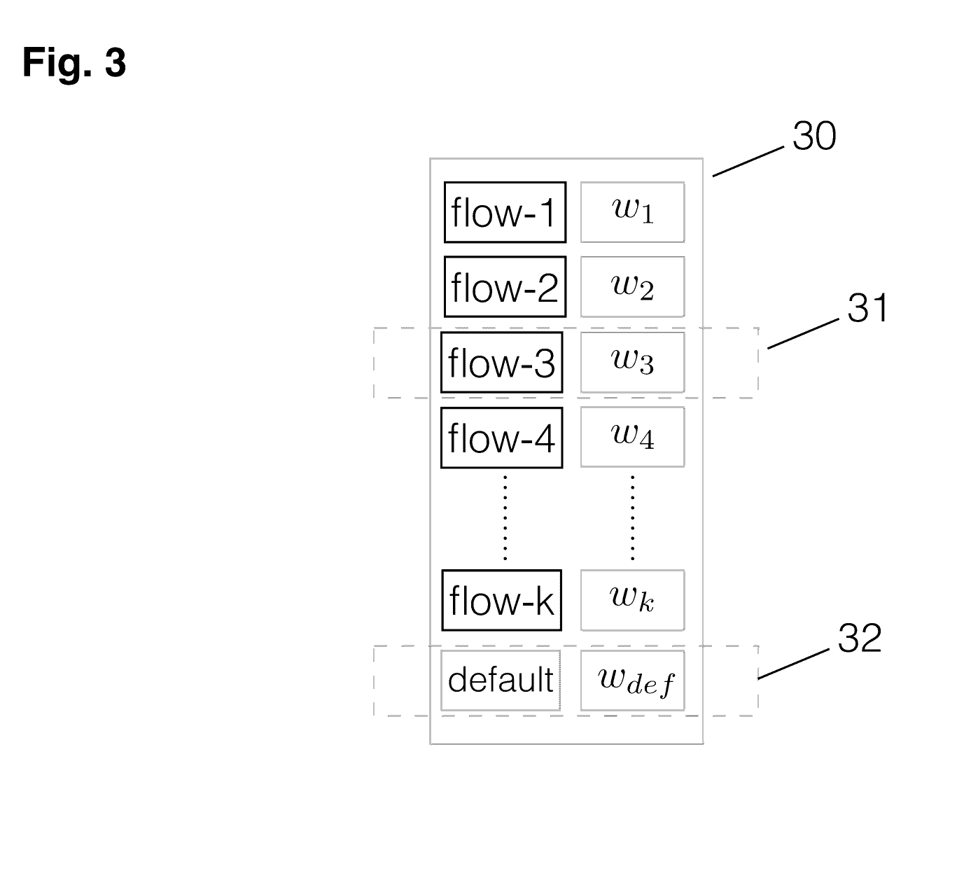

In one embodiment, the flow table (30 in FIG. 3) is composed of rows, where each row specifies a flow definition in a first column and a forwarding policy in a second column (e.g., 31 in FIG. 3). The flow definition in the said first column provides a bit mask for each supported header type and a value to be matched for the unmasked bits (e.g., bit positions with value 1) for each explicitly specified header field. For instance, if the first 24 bits of a source IPv4 address in the IP header is to be used for forwarding decision, the first 24 bits of each IPv4 packet is used and are compared against the specific value defined in the first column. A default rule is specified if no matching rule is found for the received packet (32 in FIG. 3).

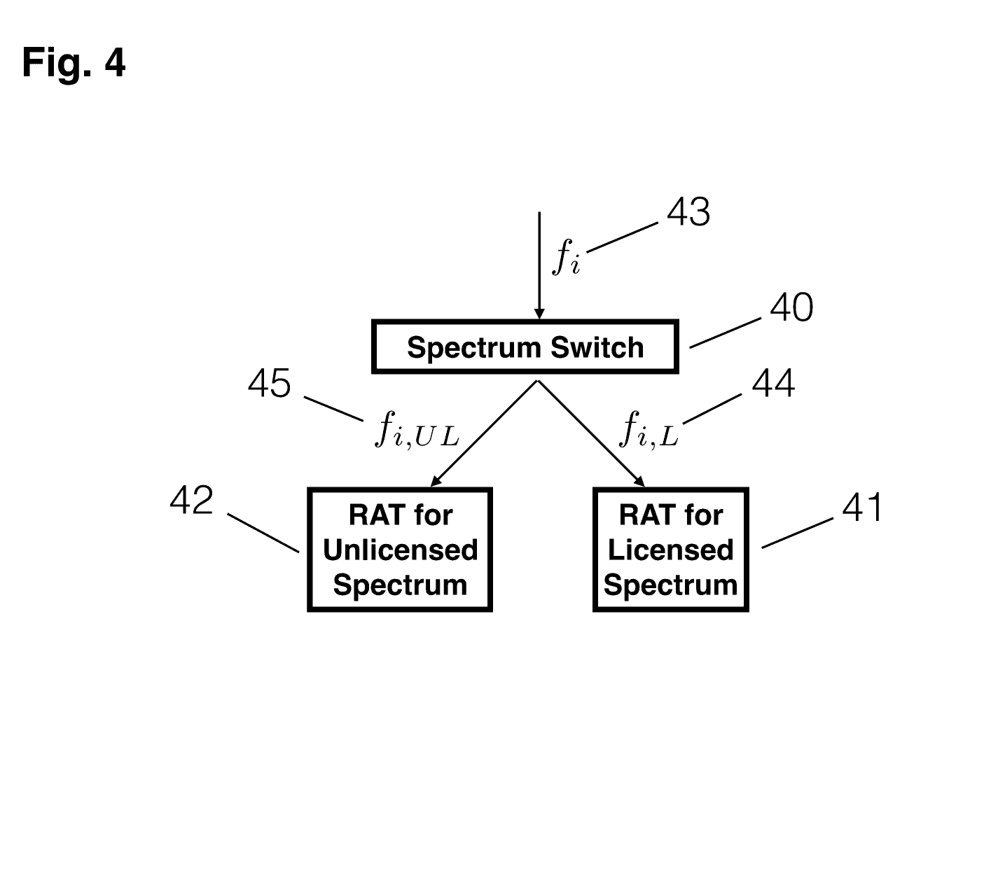

The forwarding policy in the said second column of the said flow table can be a floating number with the following convention. If 0≦wk≦1, then wk fraction of the packets for the k-th flow in the table is forwarded to the RAT operating over the licensed spectrum and (1−wk) fraction of the packets for the k-th flow in the table is forwarded to the RAT operating over the unlicensed spectrum. In FIG. 4, this situation is depicted for i-th flow, where the matching flow fi (43) is split into a first subflow fi,L (44) and forwarded onto RAT for licensed spectrum (41) as well as a second subflow fi,UL and forwarded onto RAT for unlicensed spectrum (42). In one embodiment, if more than one rule matches to the packets of the incoming flows, the longest rule match has the higher priority. In another embodiment, a third column is added to the flow table that explicitly sets the priority number, with smaller number signifying higher priority. In one embodiment, the default rule has the weight wdef=1, i.e., by default the flows are served over the licensed spectrum. In another embodiment, the default rule has the weight wdef=0, i.e., by default the flows are served over the unlicensed spectrum. When wk>1, it is treated as a numeric code for a particular forwarding policy. In one embodiment, a value wk>1 is reserved for multicasting, where flows matching to the k-th rule are copied over to both RATs. In another embodiment, another distinct value of wk>1 is reserved for coded transmission, where packets of a matching flow are coded together via a network or erasure code and the generated encoding packets are scheduled onto each RAT with a predefined rate allocation. One method of the invention dynamically programs rules for subflows of a traffic flow (e.g., a video session's flow) between a particular server and a particular UE such that one subflow is defined for high priority packets and the other subflow is defined for low priority packets. Based on the reported performance of each RAT, Spectrum Controller sets the weights of each flow such that at least the high priority subflow is forwarded to the RAT with superior performance for the QoS requirements of that subflow by setting its weight to either 0 or 1. In another embodiment, the weights of each flow is set such that the ratio of traffic forward to each RAT matches to the ratio of reported bandwidth of the said RATs.

Spectrum Switch performs flow splitting in hardware, software, or a combination of both. The flow splitting procedure is itself can be configurable or programmable. In one embodiment, the flow splitting is done as a round robin procedure such that two windows TL and TUL are defined such that w+ε<TL/(TL+TUL)<w+ε, for configurable ε parameter that measures the accuracy of weight approximation. In another embodiment, when a packet of a matching flow arrives the served fraction for licensed spectrum is compared against the target weight specified in the said second column of the said flow table and if the served fraction is below the target value, the packet is forwarded to the RAT serving the licensed spectrum, otherwise the packet is forwarded to the RAT serving the unlicensed spectrum. After assigning a packet to one RAT or the other, the served fraction for the licensed spectrum is updated.

Many of the above-described features and applications can be implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor. By way of example, and not limitation, such non-transitory computer-readable media can include flash memory, RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. The computer readable media does not include carrier waves and electronic signals passing wirelessly or over wired connections.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

In this specification, the term “software” is meant to include firmware residing in read-only memory or applications stored in magnetic storage or flash storage, for example, a solid-state drive, which can be read into memory for processing by a processor. Also, in some implementations, multiple software technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, for example microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, for example is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, for example application specific integrated circuits (ASICs) or field programmable gate arrays (FPGAs). In some implementations, such integrated circuits execute instructions that are stored on the circuit itself.

to As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

### CONCLUSION

A system and method has been shown in the above embodiments for the effective implementation of a method and apparatus for programmable spectrum switching between licensed and unlicensed spectrum. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

1. A programmable spectrum switch located on a single node comprising:
a first radio access technology (RAT) interface communicating utilizing the licensed frequency spectrum; and
a second RAT interface communicating utilizing the unlicensed frequency spectrum.

2. The programmable spectrum switch of claim 1, wherein the programmable spectrum switch stores a flow table having a flow-matching rule and a corresponding forwarding action represented by a weight.

3. The programmable spectrum switch of claim 2, wherein the flow-matching rule is specified by matching, fully or partially, one or more fields in a packet header to specific values.

4. The programmable spectrum switch of claim 3, wherein at least one of the one or more fields correspond to a destination IP address.

5. The programmable spectrum switch of claim 2, wherein a specific weight value associated with the weight specifies one of the following: (a) what fraction of packets should be forwarded to the first RAT interface utilizing the licensed frequency spectrum (b) a code vector associated with a unique policy, (c) multicasting over both the first and second RAT interfaces, (d) coded multicasting where one or more packets of the matching flow is encoded together and encoded packets are forwarded in a round robin fashion via the first and second RAT interfaces.

6. The programmable spectrum switch of claim 1, wherein the licensed frequency spectrum is composed of one contagious block of frequency bands.

7. The programmable spectrum switch of claim 1, wherein the licensed frequency spectrum is composed of a union of multiple disjoint blocks of frequency bands.

8. The programmable spectrum switch of claim 1, wherein the unlicensed frequency spectrum is composed of one contagious block of frequency bands.

9. The programmable spectrum switch of claim 1, wherein the unlicensed frequency spectrum is composed of a union of multiple disjoint blocks of frequency bands.

10. The programmable spectrum switch of claim 1, wherein the node is any of the following: a base station or a User Equipment (UE).

11. The programmable spectrum switch of claim 1, wherein the licensed spectrum corresponds to any of the following: a 3GPP standard, LTE, LTE-A, LTE-B.

12. The programmable spectrum switch of claim 1, wherein the unlicensed spectrum corresponds to any of the following: an 802.11 standard or a WiFi standard.

13. The programmable spectrum switch of claim 1, wherein the spectrum switch collects packet delivery statistics and bandwidth utilization from the first and second RATs.

14. The programmable spectrum switch of claim 13, wherein the packet delivery statistics comprises any of, or a combination of, the following: block error rates, packet drops, or number of re-transmissions.

15. The programmable spectrum switch of claim 13, wherein the collected statistics are reported on-demand or pro-actively to a remote spectrum controller.

16. The programmable spectrum switch of claim 13, wherein the programmable spectrum switch stores a flow table having a flow-matching rule and a corresponding forwarding action represented by a weight and the flow matching rules and weight are picked based on collected packet delivery statistics.

17. A programmable spectrum switch located on a single node comprising:
a first radio access technology (RAT) interface communicating utilizing the licensed frequency spectrum;
a second RAT interface communicating utilizing the unlicensed frequency spectrum,
wherein the programmable spectrum switch stores a flow table having a flow-matching rule and a corresponding forwarding action represented by a weight.

18. The programmable spectrum switch of claim 17, wherein the flow-matching rule is specified by matching, fully or partially, one or more fields in a packet header to specific values.

19. The programmable spectrum switch of claim 18, wherein at least one of the one or more fields correspond to a destination IP address.

20. The programmable spectrum switch of claim 17, wherein a specific weight value associated with the weight specifies one of the following: (a) what fraction of packets should be forwarded to the first RAT interface utilizing the licensed frequency spectrum (b) a code vector associated with a unique policy, (c) multicasting over both the first and second RAT interfaces, and (d) coded multicasting where one or more packets of the matching flow are encoded together and encoded packets are forwarded in a round robin fashion via the first and second RAT interfaces.

21. The programmable spectrum switch of claim 17, wherein the node is any of the following: a base station or a User Equipment (UE).

22. The programmable spectrum switch of claim 17, wherein the spectrum switch collects packet delivery statistics and bandwidth utilization from the first and second RATs, wherein the packet delivery statistics comprises any of, or a combination of, the following: block error rates, packet drops, or number of re-transmissions.

23. The programmable spectrum switch of claim 17, wherein the programmable spectrum switch stores a flow table having a flow-matching rule and a corresponding forwarding action represented by a weight and the flow matching rules and weight are picked based on collected packet delivery statistics.

24. An article of manufacture comprising non-transitory computer storage medium storing computer readable program code which, when executed by a processor in a single node, implements a programmable spectrum switch, the computer storage medium comprising:
computer readable program code executed by the processor to implement a first radio access technology (RAT) interface communicating utilizing the licensed frequency spectrum;
computer readable program code executed by the processor to implement a second RAT interface communicating utilizing the unlicensed frequency spectrum; and
computer readable program code executed by the processor to maintain a flow table having a flow-matching rule and a corresponding forwarding action represented by a weight, wherein the flow-matching rule is specified by matching, fully or partially, one or more fields in a packet header to specific values, and wherein a specific weight value associated with the weight specifies one of the following: (a) what fraction of packets should be forwarded to the first RAT interface utilizing the licensed frequency spectrum (b) a code vector associated with a unique policy, (c) multicasting over both the first and second RAT interfaces, and (d) coded multicasting where one or more packets of the matching flow are encoded together and encoded packets are forwarded in a round robin fashion via the first and second RAT interfaces.
